(19) United States
(12) Patent Application Publication
(10) Pub. No.: US 2010/0079070 A1
(43) Pub. Date: Apr. 1, 2010

(54) MERCURY-FREE DISCHARGE LAMP

(75) Inventors: Joanne M. Browne, Newburyport, MA (US); Arlene Hecker, Beverly, MA (US); Jeffrey W. Holt, Rockingham, NH (US)

Correspondence Address: OSRAM SYLVANIA INC, 100 ENDICOTT STREET, DANVERS, MA, 01923, US

(73) Assignee: OSRAM SYLVANIA INC., Danvers, MA (US)

(21) Appl. No.: 12/241,343

(22) Filed: Sep. 30, 2008

(51) Int. Cl. H01J 61/36

(52) U.S. Cl. 313/623

(57) ABSTRACT

A mercury-free discharge lamp includes a hollow cylindrical body, two capillaries entirely inside the body and hermetically sealed to the body, each with a respective electrode therein, where the capillaries are separated from each other inside the body by a gap that is a discharge chamber of the discharge lamp, and where each of the electrodes has an interior end exposed inside the discharge chamber and an exterior end extending beyond a respective end of the body. A pair of frit seals seal respective electrode exterior ends to respective ones of the capillaries. The discharge chamber preferably includes a mercury-free metal halide salt fill that is 10 to 54.5 wt % NaI, 6.6 to 15 wt % DyI₃, 6.7 to 15 wt % HoI₃, 6.3 to 15 wt % TmI₃, 7.2 to 12 wt % TlI, and 14.5 to 40.7 wt % CaI₂.

### BACKGROUND OF THE INVENTION

The present invention is directed to a mercury-free discharge lamp, particularly for automotive applications.

As shown in FIG. 1, a known discharge lamp 10 includes a ceramic body 12 from which capillaries 14, 16 extend. The capillaries are separated from each other within the body by a gap that defines a discharge chamber 18 that includes a salt 20 that may be mercury-free. Electrodes 22, 24 extend through the capillaries and have an exposed exterior end and an interior end inside the discharge chamber. Frits 26 seal the electrode exterior ends and the capillaries. See, for example, EP 1 550 147; U.S. Pat. No. 7,190,118; US 2007/0164679; and WO 00/67294.

It has been found that the lamps without mercury often do not perform as well as lamps with mercury. For example, the ignition voltage may be higher and the color poorer. Stability is also a problem. Since it is desirable to avoid the use of mercury, further improvements are needed. In addition, the manufacturing process can still be improved.

### SUMMARY OF THE INVENTION

An object of the present invention is to provide a novel mercury-free discharge lamp that avoids the problems of the prior art.

A further object of the present invention is to provide a novel mercury-free discharge lamp with improved color that is easier to manufacture, where the lamp includes a hollow cylindrical body, two capillaries entirely inside the body and hermetically sealed to the body, each with a respective electrode therein, where the capillaries are separated from each other inside the body by a gap that is a discharge chamber of the discharge lamp, and where each of the electrodes has an interior end exposed inside the discharge chamber and an exterior end extending beyond a respective end of the body that is sealed to the respective capillary.

A yet further object of the present invention is to provide a metal halide salt for this lamp that is 10 to 54.5 weight percent (wt %) NaI, 6.6 to 15 wt % DyI₃, 6.7 to 15 wt % HoI₃, 6.3 to 15 wt % TmI₃, 7.2 to 12 wt % TlI, and 14.5 to 40.7 wt % CaI₂.

These and other objects and advantages of the invention will be apparent to those of skill in the art of the present invention after consideration of the following drawings and description of preferred embodiments.

### BRIEF DESCRIPTION OF THE DRAWINGS

FIG. 1 is a cross sectional view of a discharge lamp of the prior art.

FIG. 2 is a cross sectional view of an embodiment of a discharge lamp of the present invention.

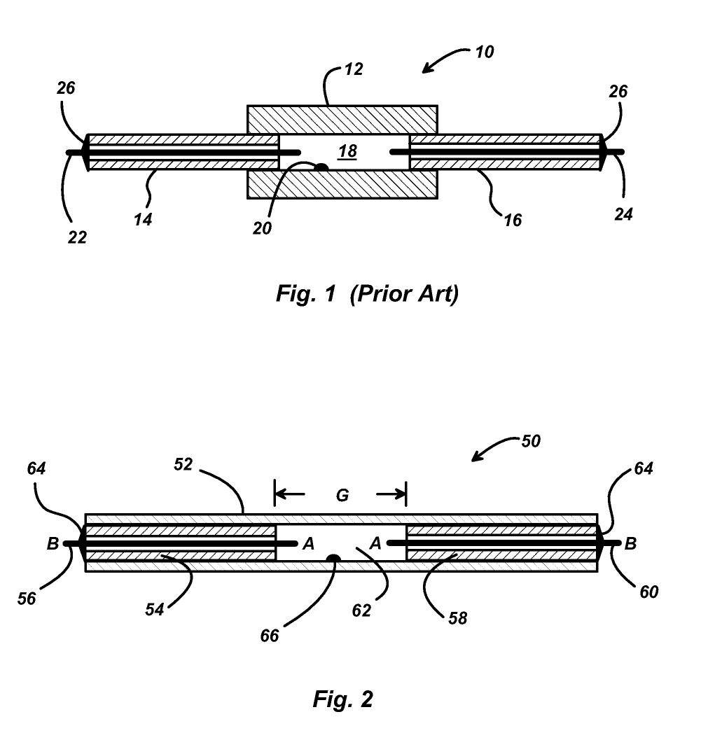

### DESCRIPTION OF PREFERRED EMBODIMENTS

With reference now to FIG. 2, an embodiment of the mercury-free discharge lamp 50 of the present invention includes a hollow cylindrical ceramic body 52, a first capillary 54 entirely inside the body and a first electrode 56 inside the first capillary, a second capillary 58 entirely inside the body and a second electrode 60 inside the second capillary. The first and second capillaries 54, 58, are separated from each other inside the body 52 by a gap G that is a discharge chamber 62 of the discharge lamp. Capillaries 54, 58 are hermetically sealed to the body 52, preferably by co-sintering with the body 52. Each of the first and second electrodes has an interior end A exposed inside the discharge chamber and an exterior end B extending beyond a respective end of the body. A pair of frit seals 64 are provided that each seals a respective electrode exterior end B and respective one of the first and second capillaries 54, 58. The frit seal may be a conventional glass/ceramic sealing composition such as Dy₂O₃/Al₂O₃/SiO₂. A mercury-free metal halide salt 66 is inside the discharge chamber. Alternatively, the lamp 50 may be defined wherein a length of the body 52 is substantially the same as a total length of the first and second capillaries 54, 58 and the gap G.

It has been found that this construction—with the tubular body 52 that extends the full length of the capillaries—provides a more uniform temperature distribution that reduces thermal stress on the feedthroughs and body 52, is easier to manufacture, and provides a more consistent volume of the discharge chamber 62.

In a more particular embodiment, the lamp includes a particular salt composition that further improves the color and reduces the ignition voltage. Further, some of the prior art lamps required acoustic straightening because the arc is bowed. When a discharge lamp is run horizontally, the bowed arc creates a temperature hot spot on the upper surface of the discharge chamber that can lead to lamp failure. It has been found that the arc in the present invention is straighter and does not need acoustic straightening. This is particularly advantageous for optical coupling to a reflector, such as in an automotive headlamp.

The discharge chamber includes Xe at 100 mbar to 16 bar pressure (8 bar preferred), and the salt is,
10 to 54.5 wt % NaI,
6.6 to 15 wt % DyI₃,
6.7 to 15 wt % HoI₃,
6.3 to 15 wt % TmI₃,
7.2 to 12 wt % TlI, and
14.5 to 40.7 wt % CaI₂.

This salt is particularly suitable for automotive applications. A particularly preferred salt composition for automotive applications is 54.5 wt % NaI, 6.6 wt % DyI₃, 6.7 wt % HoI₃, 6.3 wt % TmI₃, 11.4 wt % TlI, and 14.5 wt % CaI₂. In such applications, the lamp may take a particular size, with the body 52 being 24 mm long, the gap G 6 mm, and each of the capillaries 9 mm long. The body has an outer diameter of 2 mm and the discharge chamber 62 has a diameter of 1.2 mm. The capillaries have an opening 0.54 mm in diameter through which the electrodes extend. The electrodes may have a diameter of 0.24 mm and may be spaced about 5.25 mm apart. A larger electrode (e.g., 0.265 mm in diameter) allows larger run-up currents to be applied. In this particular embodiment, about 0.5 mg of the salt is in the discharge chamber.

One of skill in the art may modify the salt components, gas fill, and pressure within the specified parameters to achieve desired lamp properties, such as accelerating the run-up (e.g., by increasing Xe pressure) for a particular application.

The term “length” as used herein refers to the longitudinal extent, and the term end refers to the longitudinal end. The term “substantially” refers to measurement accuracy acceptable in the art.

While embodiments of the present invention have been described in the foregoing specification and drawings, it is to be understood that the present invention is defined by the following claims when read in light of the specification and drawings.

We claim:

1. A mercury-free discharge lamp, comprising:
a hollow cylindrical ceramic body;
a first capillary entirely inside the body and hermetically sealed to the body, and a first electrode inside the first capillary;
a second capillary entirely inside the body and hermetically sealed to the body, and a second electrode inside the second capillary,
wherein the first and second capillaries are separated from each other inside the body by a gap that is a discharge chamber of the discharge lamp, and wherein each of the first and second electrodes has an interior end exposed inside the discharge chamber and an exterior end extending beyond a respective end of the body;
a pair of frit seals that each seals a respective electrode exterior end to a respective one of the first and second capillaries; and
a mercury-free metal halide salt inside the discharge chamber.

2. The lamp of claim 1, further comprising Xe at 100 mbar to 16 bar pressure inside the discharge chamber, and wherein the salt comprises,
10 to 54.5 wt % NaI,
6.6 to 15 wt % DyI₃,
6.7 to 15 wt % HoI₃,
6.3 to 15 wt % TmI₃,
7.2 to 12 wt % TlI, and
14.5 to 40.7 wt % CaI₂.

3. The lamp of claim 2, wherein the body length is about 24 mm and the gap is about 6 mm.

4. A mercury-free discharge lamp, comprising:
a hollow cylindrical ceramic body;
a first capillary inside the body and hermetically sealed to the body, and a first electrode inside the first capillary;
a second capillary inside the body and hermetically sealed to the body, and a second electrode inside the second capillary;
wherein the first and second capillaries are separated from each other inside the body by a gap that is a discharge chamber of the discharge lamp, wherein a length of the body is substantially the same as a total length of the first and second capillaries and the gap, and wherein each of the first and second electrodes has an interior end exposed inside the discharge chamber and an exterior end extending beyond a respective end of the body;
a pair of frit seals that each seals a respective electrode exterior end to a respective one of the first and second capillaries; and
a mercury-free metal halide salt inside the discharge chamber.

5. The lamp of claim 4, further comprising Xe at 100 mbar to 16 bar pressure inside the discharge chamber, and wherein the salt comprises,
10 to 54.5 wt % NaI,
6.6 to 15 wt % DyI₃,
6.7 to 15 wt % HoI₃,
6.3 to 15 wt % TmI₃,
7.2 to 12 wt % TlI, and
14.5 to 40.7 wt % CaI₂.

6. The lamp of claim 4, wherein the body length is about 24 mm and the gap is about 6 mm.

7. The lamp of claim 2, wherein the salt comprises 54.5 wt % NaI, 6.6 wt % DyI₃, 6.7 wt % HoI₃, 6.3 wt % TmI₃, 11.4 wt % TlI, and 14.5 wt % CaI₂.

8. The lamp of claim 5, wherein the salt comprises 54.5 wt % NaI, 6.6 wt % DyI₃, 6.7 wt % HoI₃, 6.3 wt % TmI₃, 11.4 wt % TlI, and 14.5 wt % CaI₂.

9. The lamp of claim 3, wherein the discharge chamber has a diameter of 1.2 mm.

10. The lamp of claim 6, wherein the discharge chamber has a diameter of 1.2 mm.
